(19) United States
(12) Patent Application Publication
(10) Pub. No.: US 2009/0230306 A1
(43) Pub. Date: Sep. 17, 2009

(54) Spectroscopic Prediction of Formaldehyde Emission and Thickness Swell of Wood Panels

(76) Inventors: Nicolas ANDRE, Knoxville, TN (US); Timothy M. Young, Knoxville, TN (US); Timothy G. Rials, Maryville, TN (US)

Correspondence Address: PITTS AND BRITTIAN P C, P O BOX 51295, KNOXVILLE, TN, 37950-1295, US

(21) Appl. No.: 12/404,751

(22) Filed: Mar. 16, 2009

Related U.S. Application Data
(60) Provisional application No. 61/037,171, filed on Mar. 17, 2008.

(51) Int. Cl. G01J 5/02

(52) U.S. Cl. 250/339.09

(57) ABSTRACT

A process for spectroscopic measurement of the emission of formaldehyde from refined wood products destined to be used in the manufacture of composite wood products such as medium density fiberboard (MDF), particleboard, and plywood. The process employs near-infrared (NIR) spectroscopy to measure the absorption of light by the wood furnish; the level of absorption is then related to the formaldehyde emission and thickness swell of the finished wood panel. This process allows for real-time quantitative prediction of future formaldehyde emissions and thickness swell of a composite wood panel.

### CROSS-REFERENCE TO RELATED APPLICATIONS

Not Applicable

### STATEMENT REGARDING FEDERALLY-SPONSORED RESEARCH OR DEVELOPMENT

Not Applicable

### BACKGROUND OF THE INVENTION

1. Field of Invention

The present invention relates to methods and apparatus for measuring the emission of formaldehyde from composite wood products and for measuring the thickness swell of a composite wood panel. More specifically, the present invention relates to the use of near-infrared spectroscopy to measure the absorption of electromagnetic radiation by the wood furnish, allowing the real-time prediction of formaldehyde emissions and thickness swell of a composite wood panel.

2. Description of the Related Art

Formaldehyde is naturally present in solid wood. Additionally, composite wood products such as medium density fiberboard (MDF), particleboard, and plywood use resins like urea-formaldehyde. Over time, urea-formaldehyde and similar resin materials can undergo chemical reactions that result in the outgassing (emission) of formaldehyde. In recent years, the results of scientific studies have led government agencies and other organizations to designate formaldehyde as a carcinogen. Therefore, there is a need to limit the amount of formaldehyde that composite wood products emit over their useful lifetimes. The problem is especially significant because composite wood products like plywood are often used in the construction of residential dwellings, where formaldehyde emissions may concentrate in the confined space of the home. In the United States, 24 C.F.R. § 3280.308 sets forth limits for the formaldehyde emission levels in plywood and particleboard materials when used in certain circumstances, such as the construction of manufactured homes.

A number of methods for measuring formaldehyde emissions are known in the prior art. One test, known as the FTM-2 test, involves placing a number of panels in a test chamber and passing air through the chamber. The panels are first conditioned for seven days at constant temperature (75° F.) and constant relative humidity (50%) prior to being placed in the testing chamber. After the panels are placed in the chamber, air is passed over the panels to mix with the formaldehyde vapor emitted from the panels. The air in the chamber is continuously removed and replaced with clean air at a constant rate, and the removed air is tested for its concentration of formaldehyde. Under the FTM-2 test, the panels are tested in the chamber for 16-20 hours. The FTM-2 test generally gives reliable results and has been adopted as the official test for some federal regulations, notably 24 C.F.R. § 3280.406. However, the test has serious disadvantages. The chief drawback to the FTM-2 test is the long lag time between the production of a composite wood product and the time that the formaldehyde emissions figure for that product is known: seven days for conditioning and almost a full day for testing. With the FTM-2 test, the level of formaldehyde emission for a given sample will only be known over a week after that sample and other pieces have been taken from the production line.

Another test, known as the FTM-1 test or the “desiccator test,” involves placing a number of panels in a desiccator with a petri dish of water. Some of the formaldehyde emitted from the panels into the air in the desiccator is dissolved in the water of the petri dish. After two hours, a sample of the water from the petri dish is tested for the concentration of dissolved formaldehyde using the chromotropic acid method. The FTM-1 test requires 24 hours of conditioning of the panels before testing and two hours for the testing itself. Thus, the FTM-1 test is much faster than the FTM-2 test but is still far from real-time. Again, the level of formaldehyde emission for a given sample will only be known long after that sample and other pieces have been taken from the production line. Further, the FTM-1 test generally gives substantially less accurate results than the FTM-2 test. Clearly, a need is felt for accurately predicting formaldehyde emissions in real-time.

Thickness swell relates to the stability of a wood-based panel when put in contact with water. For instance, medium density hardboard is used extensively as siding on residential structures. Its stability to water exposure is very important.

Predicting formaldehyde emission and thickness swell in real-time can help identifying problems in the production and controlling the number of “reject” panels (i.e. formaldehyde emissions or thickness swell value is beyond the acceptable level). Clearly, a need is felt for predicting formaldehyde emissions and thickness swell in real-time.

### BRIEF SUMMARY OF THE INVENTION

The present invention comprises the use of a spectrometer and a light source positioned above the forming belt in an assembly line where composite wood panels are formed. The process involves shining light in the infrared or near infrared wavelengths on the composite wood product (“CWP”) furnish as it is being formed into a finished panel. A sensor calibrated to detect the selected wavelengths then senses light reflected off the CWP furnish. The sensor communicates the reflected light data to a spectrometer. By comparing the light shone upon the CWP furnish with the light detected by the sensor, it is possible to measure the degree to which the light in the selected wavelengths has been absorbed by the furnish and relate it to the formaldehyde emission of the corresponding finished panel. Multivariate analyses such as partial least squares are employed to generate a calibration model relating the collected spectra to the results of FTM-2 or FTM-1 tests (or any other formaldehyde test device used by the CWP manufacturer).

### DESCRIPTION OF THE DRAWINGS

The foregoing features of the invention will be more fully described with reference to the drawings, of which

FIG. 1 is a block diagram representation of one embodiment of the invention;

FIG. 2 is a representation of one embodiment of the invention including a reference system;

FIG. 3 is another view of the embodiment shown in FIG. 2.

FIG. 4 is another view of the embodiment shown in FIG. 2 and FIG. 3;

FIG. 5 is a graph showing the correlation between formaldehyde emission values predicted by near infrared spectroscopy and actual formaldehyde emission values as measured by the FTM-2 test;

FIG. 6 is a graph showing the correlation between thickness swell values predicted by near infrared spectroscopy and actual thickness swell; and

FIG. 7 shows the regression coefficients for different wavelengths obtained for the calibration model using two principal components, to be used for future prediction of the thickness swell when a new spectrum is presented to the calibration model.

### DESCRIPTION OF THE INVENTION

The present invention, i.e. a process for real-time quantitative measurement of the emission of formaldehyde from wood products using near-infrared spectroscopy, is described more fully hereinafter. From the outset, it is worth noting that this invention may be embodied in many different forms and should not be construed as limited to the specific embodiments described herein.

In general terms, the present invention comprises the use of a spectrometer and a light source positioned near the forming belt in an assembly line where CWP panels are formed. The light source shines light in the infrared or near infrared wavelengths on the CWP as it is being formed into a finished panel, i.e. when the CWP is still a “furnish” or unfinished panel. The spectrometer, through a sensor calibrated to detect the selected wavelengths, measures light reflected off the CWP furnish. By comparing the light shone upon the CWP furnish with the light detected by the sensor, it is possible to measure the degree to which the light in the selected wavelengths has been absorbed by the CWP furnish.

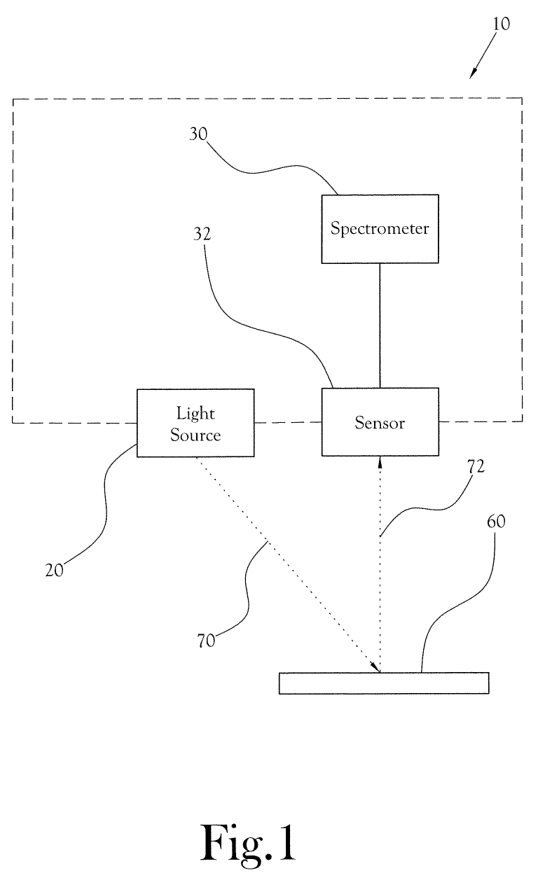

One embodiment of the present invention involves a spectroscopy device installed above the assembly line where the composite wood panels are formed. As seen in FIG. 1, the invention comprises a light source 20 and a spectrometer 30 in communication with a sensor 32 calibrated to detect the selected wavelengths emitted by the light source 20. The light source 20 shines light onto the CWP furnish 60, and some of that light is reflected into the sensor 32. By comparing the light 70 shone upon the CWP furnish 60 with the light 72 detected by the sensor 32, it is possible to measure the absorption of light in the selected wavelengths by the CWP furnish 60 and relate it to the formaldehyde gasses coming off the finished CWP. In some embodiments, the light source 20, sensor 32 and spectrometer 30 are all housed in a single housing 10 suspended above the location where the CWP mat is formed.

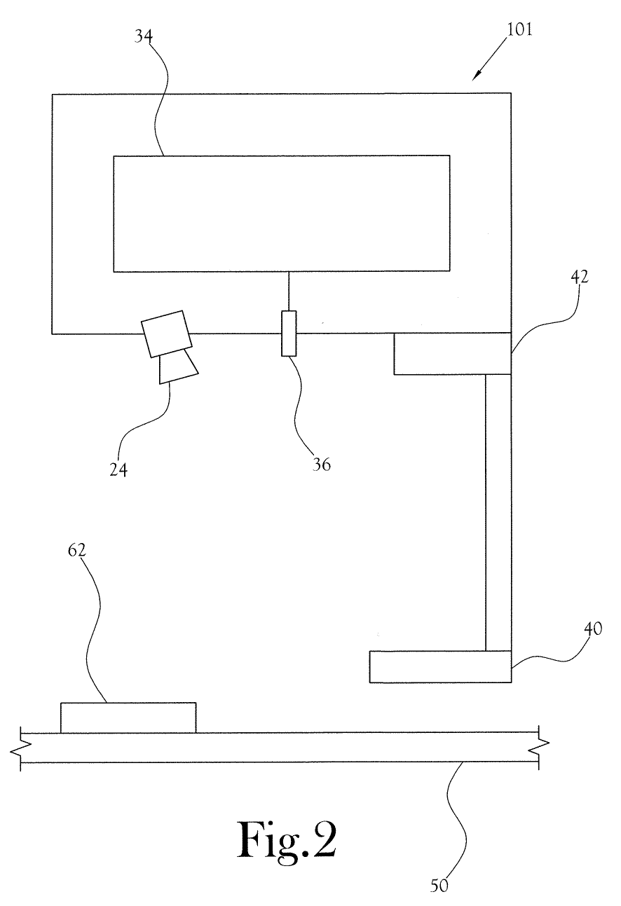

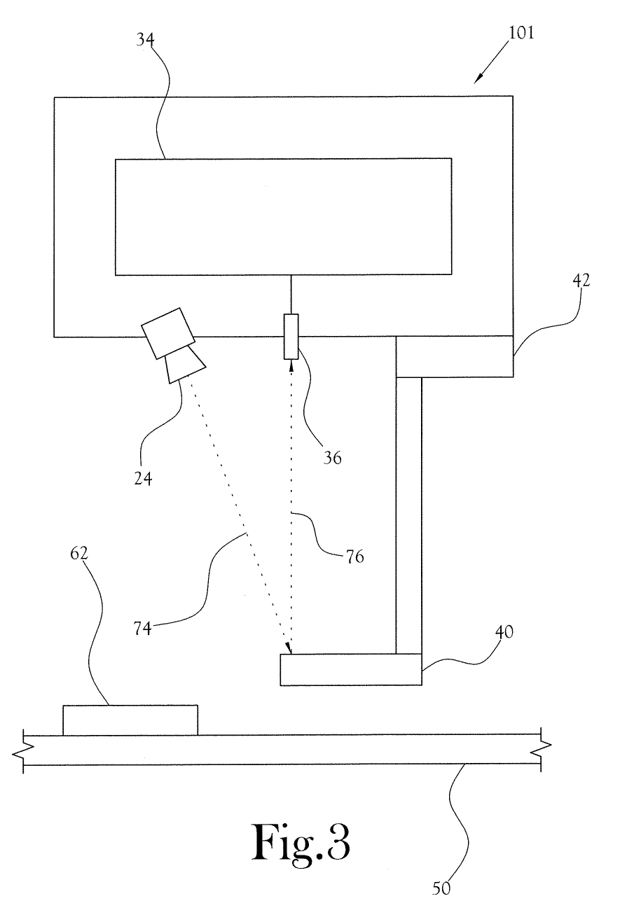

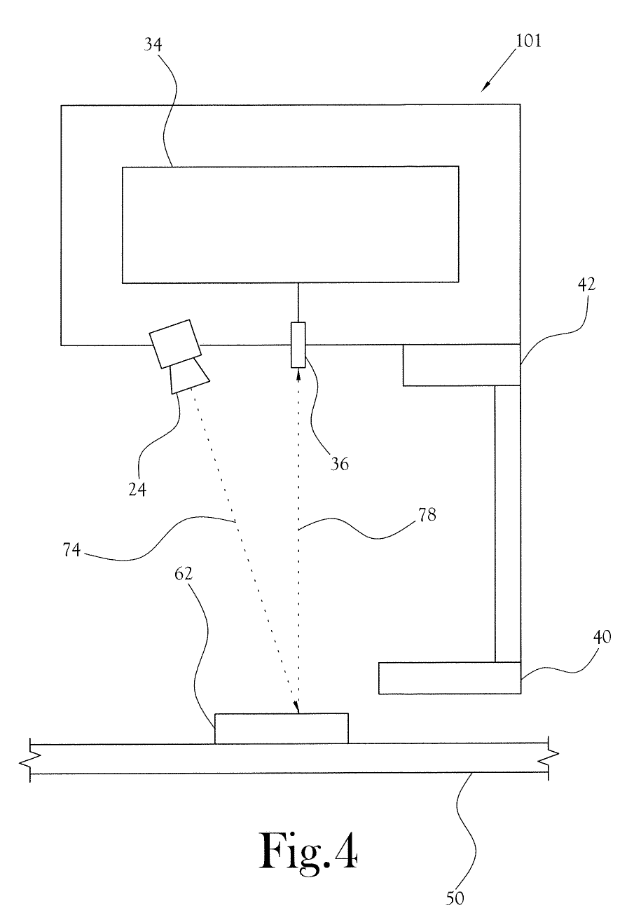

Another more detailed embodiment of the present invention is shown in FIG. 2, FIG. 3, and FIG. 4. As seen in FIG. 2, the device 101 includes a light source 24, a spectrometer 34, and a sensor 36 in communication with the spectrometer 34. In some embodiments of the invention, the sensor 36 is an optical fiber that conveys the received light to the spectrometer 34. The device 101 is suspended above the forming belt 50 through support means (not shown). The forming belt 50 carries the CWP 62, which is still a “furnish” or unfinished panel at this stage in the production process. The apparatus 101 also comprises a white reference material 40 used in providing reference points for the spectrometer, and a means 42 for moving the white reference material 40 into position.

The apparatus 101 carries out the testing as follows. The light source 24 is switched off (i.e. to a non-emitting condition) in order to give the spectrometer 34 a “dark” reference point. Then, as shown in FIG. 3, the white reference material 40 is maneuvered into position under the sensor 36 by the reference material moving means 42. In some embodiments, the reference material moving means 42 comprises an air-cylinder-powered mechanical arm; however, those of skill in the art will recognize that other means exist. The light source 24 then shines light 74 in the selected wavelengths onto the white reference material 40. The white reference material 40 reflects the light 76 toward the sensor 36, thereby giving the spectrometer a “white” reference point. Next, as shown in FIG. 4, the reference material moving means 42 moves the white reference material 40 out from under the sensor 36. The forming belt 50 moves the CWP furnish 62 into position under the sensor 36, and the light source 24 shines light 74 onto the CWP furnish 62. The sensor 36 detects and the spectrometer 34 records the spectrum of the light 78 reflected off of the CWP furnish 62.

### EXPERIMENTAL RESULTS

In a test of one embodiment of the present invention, a spectroscopy device was installed above the assembly line where medium density fiberboard (MDF) is formed. The spectroscopy device comprises an Ocean Optics (USB 2000) near-infrared spectrometer operating in the 650-990 nm range, an optical fiber, a light source (tungsten-halogen bulb), and an automated reference system (a solid state relay switches off the light so a “dark” spectrum can be collected; an air cylinder powered arm moves a white reference material under the optical fiber so a “white reference” spectrum can be collected).

In the study, a near-infrared spectrum of a sample panel was collected every 30 minutes. The manufactured panel corresponding to the analyzed furnish was extracted for further formaldehyde emission and thickness swell testing, including the FTM-2 test. A total of 43 spectra and their corresponding panel thickness swell and formaldehyde emission values were used to build calibration models. Spectral data were normalized (mean normalization) prior to the regression routines. As seen in FIG. 1, the NIR spectra are collected above the MDF furnish while the thickness swell and formaldehyde emission are measured on the corresponding finished panels.

Partial Least Squares (PLS1) regression was used to build a calibration model and perform a full cross-validation (LOO, leave one out) routine between the spectra and the thickness swell values. The thickness swell values were measured after completion of the continuous 24 hours soaking test (ASTM D1037-99).

As the calibration model for the formaldehyde emissions built with PLS1 (Martens and Noes 1989) exhibited some non-linear behavior, feedforward neural networks (Demuth et al. 2006) were employed to build a calibration model and perform the full cross-validation routine (Isaksson and Naes 1988). The formaldehyde emission values were measured by the FTM-2 test.

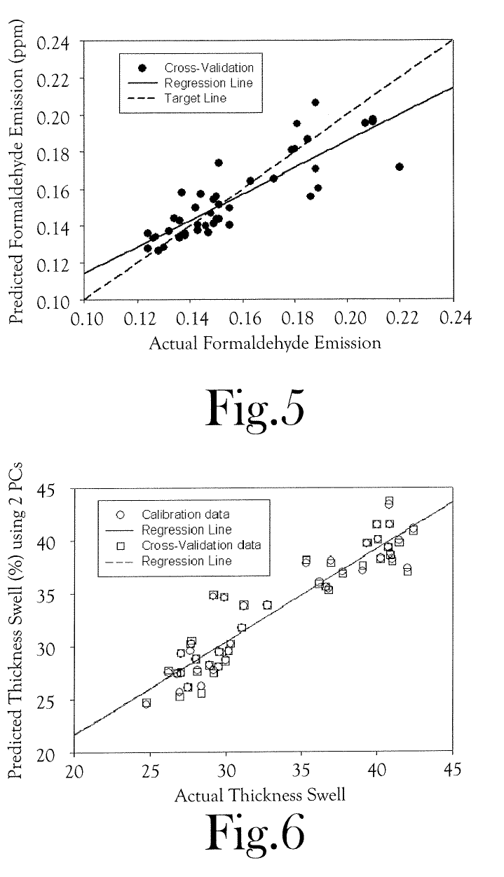

Feedforward neural networks were used to build a relationship (calibration model) between the collected spectra (X) and the formaldehyde emission values (y). A full cross-validation was also performed to give an estimate of the performance of the calibration model when presented to new spectral data. As shown in FIG. 5, the correlation coefficient between predicted and actual (FTM-2) values was of 0.857, with a root mean square error of cross-validation of 0.0135 ppm and a coefficient of variation of 8.59% (Table 1).

FIG. 6 shows the calibration model and cross-validation results for thickness swell data found by PLS1 using two principal components. A correlation coefficient of 0.94 was found between the actual thickness swell values and the predicted ones, with a root mean square error of calibration (RMSEC) of 1.95% and a coefficient of variation of 5.84%.

Concerning the cross-validation, a correlation coefficient of 0.93 was obtained between the predicted thickness swell values and the actual ones, with a root mean square error of cross-validation (RMSECV) of 2.09% and a coefficient of variation of 6.24% (Table 1).

TABLE 1
Calibration and cross-validation results: correlation coefficient (r), root
mean square error (RMSE) and coefficient of variation (CV) for
formaldehyde emission and thickness swell data

| | r_{cal} | RMSEC | CV_{cal} | rₓ₋ᵥₐₗ | RMSECV | CVₓ₋ᵥₐₗ |
|---|---|---|---|---|---|---|
| Formaldehyde | 0.95 | 0.0081 | 5.19% | 0.857 | 0.0135 ppm | 8.59% |
| emissions | | ppm | | | | |
| (using neural | | | | | | |
| networks) | | | | | | |
| Thickness | 0.94 | 1.95% | 5.84% | 0.93 | 2.09% | 6.24% |
| Swell (using | | | | | | |
| PLS1) | | | | | | |

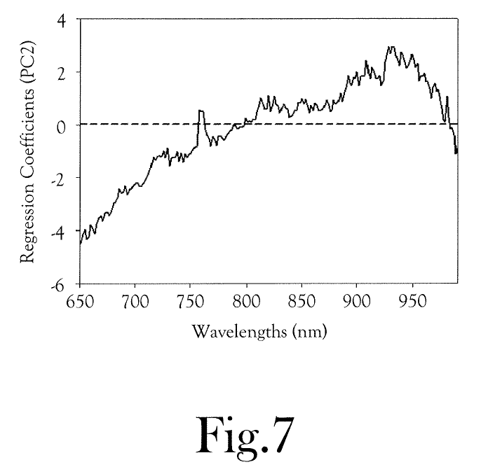

FIG. 7 shows the regression coefficients obtained for the calibration model using two principal components. The regression coefficients are used for future prediction of the thickness swell when a new spectrum is presented to the calibration model.

Table 1 (supra) gives an overview of the calibration and cross-validation statistics for both formaldehyde emission and thickness swell data. The cross-validation results give an estimate of the prediction performance of the calibration models.

While the present invention has been illustrated by description of one embodiment, and while the illustrative embodiment has been described in detail, it is not the intention of the applicant to restrict or in any way limit the scope of the appended claims to such detail. Additional modifications will readily appear to those skilled in the art. The invention in its broader aspects is therefore not limited to the specific details, representative apparatus and methods, and illustrative examples shown and described. Accordingly, departures may be made from such details without departing from the spirit or scope of applicant's general inventive concept.

Having thus described the aforementioned invention, what is claimed is:

1. A method for predicting formaldehyde emissions from a composite wood product bonded with a urea-formaldehyde resin adhesive, said method comprising
providing spectroscopic instrumentation including a source of electromagnetic radiation with a wavelength range in the near-infrared range of the electromagnetic spectrum, and sensor means for wavelengths within said wavelength range;
calibrating said spectroscopic instrumentation for non-invasive quantitative measurement of formaldehyde emission from said composite wood product;
establishing that a pre-determined relationship exists between quantitative formaldehyde emission from said composite wood product and absorption of radiation in said wavelength range;
placing a furnish of said composite wood product in proximity to said source of electromagnetic radiation and said sensor means;
activating said source of electromagnetic radiation so that electromagnetic irradiation within said wavelength range is directed toward said furnish of said composite wood product; and
recording through said sensor means the electromagnetic radiation reflected from said furnish of said composite wood product.

2. The process of claim 1 wherein said wavelength range is between 650 nanometers and 1000 nanometers.

3. The process of claim 1 wherein said wavelength range is between 650 nanometers and 990 nanometers.

4. The process of claim 1 wherein said wavelength range is between 650 nanometers and 900 nanometers.

5. A process for utilizing electromagnetic-radiation spectroscopic instrumentation for quantitative measurement of the emission of formaldehyde from materials to be used in the manufacture of composite wood products, said process comprising
providing spectroscopic instrumentation including a source of electromagnetic radiation with a wavelength range in the near-infrared range of the electromagnetic spectrum, and sensor means for wavelengths within said wavelength range;
calibrating said spectroscopic instrumentation for non-invasive quantitative measurement of formaldehyde emission from said composite wood product;
establishing that a pre-determined relationship exists between quantitative formaldehyde emission from said composite wood product and absorption of radiation in said wavelength range;
placing said composite wood product furnish in proximity to said source of electromagnetic radiation and said sensor means;
activating said source of electromagnetic radiation so that electromagnetic irradiation within said wavelength range is directed toward said composite wood product furnish; and
recording through said sensor means the electromagnetic radiation reflected from said composite wood product furnish.

6. The process of claim 5 wherein said wavelength range is between 650 nanometers and 1000 nanometers.

7. The process of claim 5 wherein said wavelength range is between 650 nanometers and 990 nanometers.

8. The process of claim 5 wherein said wavelength range is between 650 nanometers and 900 nanometers.

9. A method for predicting thickness swell of a composite wood product bonded with a urea-formaldehyde resin adhesive, said method comprising
providing spectroscopic instrumentation including a source of electromagnetic radiation with a wavelength range in the near-infrared range of the electromagnetic spectrum, and sensor means for wavelengths within said wavelength range;
calibrating said spectroscopic instrumentation for non-invasive quantitative measurement of thickness swell of said composite wood product;
establishing that a pre-determined relationship exists between quantitative thickness swell of said composite wood product and absorption of radiation in said wavelength range;
placing said composite wood product furnish in proximity to said source of electromagnetic radiation and said sensor means;
activating said source of electromagnetic radiation so that electromagnetic irradiation within said wavelength range is directed toward said composite wood product furnish; and
recording through said sensor means the electromagnetic radiation reflected from the composite wood product furnish.

10. The process of claim 9 wherein said wavelength range is between 650 nanometers and 1000 nanometers.

11. The process of claim 9 wherein said wavelength range is between 650 nanometers and 990 nanometers.

12. The process of claim 9 wherein said wavelength range is between 650 nanometers and 900 nanometers.
